(19) United States
(12) Patent Application Publication
(10) Pub. No.: US 2020/0257586 A1
(43) Pub. Date: Aug. 13, 2020

(54) INFORMATION PROCESSING DEVICE, LEARNING DEVICE, AND NON-TRANSITORY RECORDING MEDIUM STORING MACHINE-LEARNED MODEL

(71) Applicant: SEIKO EPSON CORPORATION, Tokyo (JP)

(72) Inventor: Daiki KOBAYASHI, SHIOJIRI-SHI (JP)

(21) Appl. No.: 16/789,125

(22) Filed: Feb. 12, 2020

(30) Foreign Application Priority Data
Feb. 13, 2019 (JP) 2019-023427

(51) Int. Cl. G06F 11/07; G06N 20/00

(52) U.S. Cl. CPC G06F 11/0793; G06Q 10/087; G06N 20/00; G06F 11/0721

(57) ABSTRACT

An information processing device includes a storage configured to store a machine-learned model, a reception section configured to receive error information and operation information transmitted from an electronic apparatus, and a prosessor configured to present a recommended countermeasure against an error indicated by the received error information based on the machine-learned model. The machine-learned model mechanically learns a condition of a recommended countermeasure against the error based on a data set in which the error information, the operation information, and the countermeasure information indicating the countermeasure performed against the error are associated with one another.

The present application is based on, and claims priority from JP Application Serial Number 2019-023427, filed Feb. 13, 2019, the disclosure of which is hereby incorporated by reference herein in its entirety.

### BACKGROUND

### 1. Technical Field

The present disclosure relates to an information processing device, a learning device, and a non-transitory recording medium storing a machine-learned model.

### 2. Related Art

It is important for a user to employ an appropriate countermeasure to realize stable operation of an electronic apparatus. In general, a method for supporting the countermeasure employed by the user has been used. For example, JP-A-2008-211662 discloses a method for generating maintenance information including information indicating a countermeasure when an error occurs in a printer. In JP-A-2008-211662, maintenance information is generated by searching a database based on error information indicating an error type and status information indicating a status at a time of occurrence of an error. The database stores different countermeasures for different models, different error types, and different statuses at times of errors.

When a process of searching a database is used as disclosed in JP-A-2008-211662, an appropriate countermeasure may not be searched for. To configure a database, conditions are required to be set for determining countermeasures based on a model, an error type, and a status. When a user manually sets the conditions, the user's burden is considerably heavy.

### SUMMARY

According to an aspect of the present disclosure, an information processing device includes a storage configured to store a machine-learned model obtained by mechanically learning a condition of a recommended countermeasure against an error based on a data set in which error information indicating the error generated in an electronic apparatus, operation information indicating an operation state of the electronic apparatus, and countermeasure information indicating the countermeasure performed against the error are associated with one another, a reception section configured to receive the error information and the operation information transmitted from the electronic apparatus, and a prosessor configured to present the recommended countermeasure against the error indicated by the received error information based on the machine-learned model.

### BRIEF DESCRIPTION OF THE DRAWINGS

FIG. 1 is a diagram illustrating an example of a configuration of a print system.

FIG. 2 is a diagram illustrating examples of configurations of recording heads and an ink supply device.

FIG. 3 is a diagram illustrating an example of a configuration of a system including an information collecting system.

FIG. 4 is a diagram illustrating an example of a display screen used to browse information on electronic apparatuses.

FIG. 5 is a diagram illustrating an example of a display screen used to browse information on electronic apparatuses.

FIG. 6 is a diagram illustrating an example of an error notification.

FIG. 7 is a diagram illustrating an example of a configuration of a learning device.

FIG. 8 is a diagram illustrating examples of data sets used for a learning process.

FIG. 9 is a diagram illustrating examples of data sets used for a learning process.

FIG. 10 is a diagram illustrating a configuration of a neural network.

FIG. 11 is a diagram illustrating backpropagation.

FIG. 12 is a diagram illustrating an example of an information processing device executing an estimation process.

FIG. 13 is a diagram illustrating examples of input data and output data in the estimation process.

FIG. 14 is a diagram illustrating examples of input data and output data in the estimation process.

FIG. 15 is a flowchart of the estimation process.

FIG. 16 is a diagram illustrating an example of a display screen for offering countermeasures.

FIG. 17 is a diagram illustrating an example of another information processing device executing an estimation process.

FIG. 18 is a diagram illustrating examples of input data and output data in the estimation process.

### DESCRIPTION OF EXEMPLARY EMBODIMENTS

An embodiment will be described hereinafter. Note that the embodiment described herein does not unreasonably limit content disclosed in claims. Furthermore, all components described in this embodiment may not be requirements.

### 1. Outline

As described above, a method for supporting a countermeasure performed by a user when an error occurs in an electronic apparatus has been used. Examples of the electronic apparatus include a printer. The examples of the electronic apparatus further include a scanner, a facsimile device, and a photocopier. The examples of the electronic apparatus further include a multifunction peripheral (MFP) having a plurality of functions, and a multifunction peripheral having a print function is also an example of a printer. The examples of the electronic apparatus further include a projector, a head-mounted display device, a wearable apparatus, a living body information measurement apparatus, such as a pulse monitor or an activity meter, a robot, a video apparatus, such as a camera, a mobile information terminal, such as a smartphone, and a physical quantity measurement apparatus.

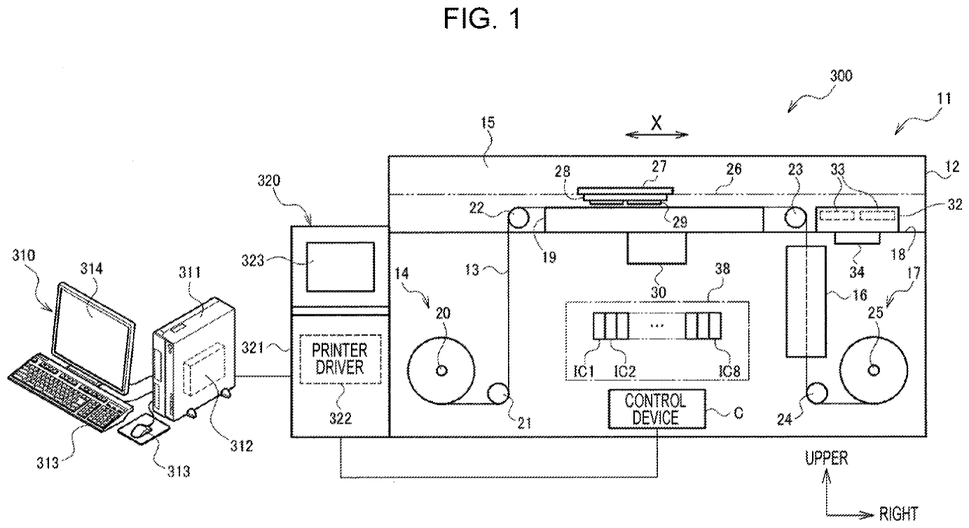

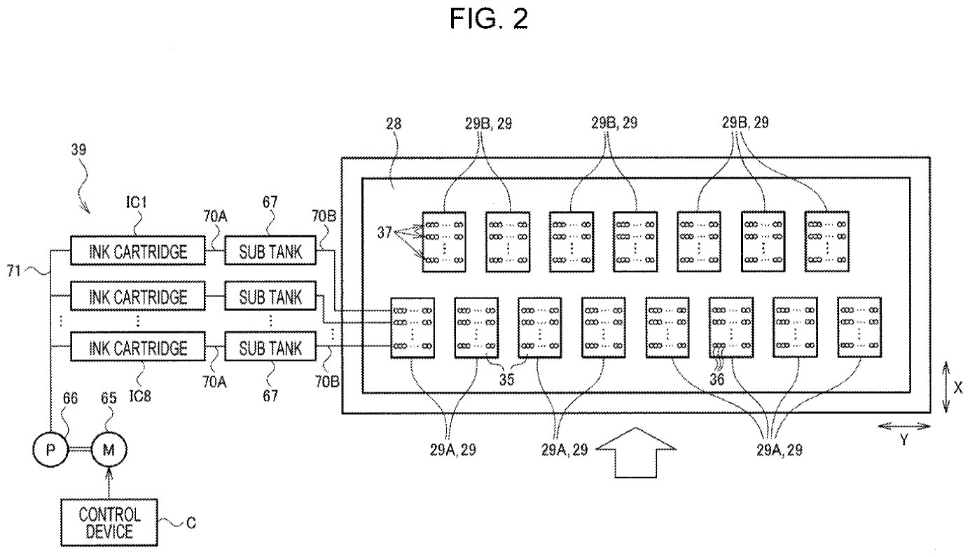

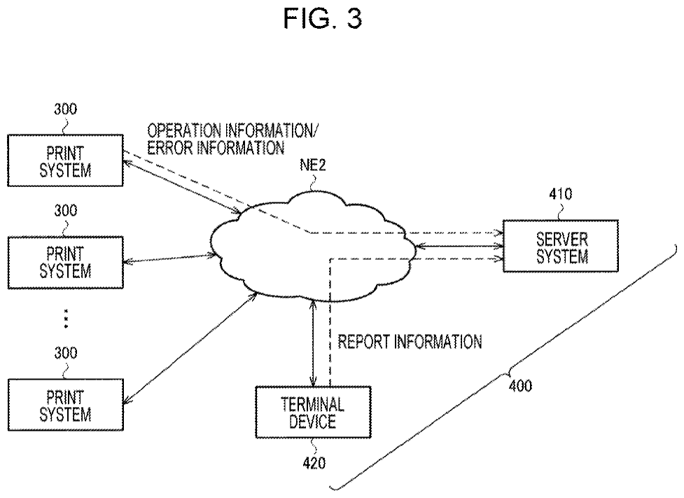

Hereinafter, an example in which the electronic apparatus is a printer will be described. A configuration of a print system 300 including a printer will now be described in detail with reference to FIGS. 1 and 2. Thereafter, an information collecting system 400 will be described with reference to FIG. 3.

FIG. 1 is a diagram schematically illustrating the print system 300. As illustrated in FIG. 1, the print system 300 includes an image generation apparatus 310, a host apparatus 320, and a printer 11. The printer 11 is a lateral type ink jet printer.

The image generation apparatus 310 is a personal computer (PC), for example. The image generation apparatus 310 includes an image generation section 312 realized when a central processing unit (CPU) included in a main body 311 executes image generation software. The user operates an input apparatus 313 so as to generate an image on a monitor 314 after activating the image generation section 312. Furthermore, the user instructs print of the generated image by operating the input apparatus 313. The image generation apparatus 310 transmits image data corresponding to the generated image to the host apparatus 320 through a predetermined communication interface based on the instruction.

The host apparatus 320 is a PC, for example, and includes a printer driver 322 realized when a CPU included in a main body 321 executes printer driver software. The printer driver 322 generates print data based on the image data supplied from the image generation apparatus 310 and transmits the generated print data to a control device C mounted on the printer 11. The control device C controls the printer 11 based on the print data supplied from the printer driver 322 and causes the printer 11 to print an image based on the print data. Note that a menu screen used to input and set setting values for control to the printer 11, an image to be printed, and the like are displayed in a monitor 323.

Next, a configuration of the printer 11 illustrated in FIG. 1 will be described. Note that a “left-right direction” and an “upper-lower direction” in a description in the specification below are described based on directions denoted by arrow marks in FIG. 1. Furthermore, a near side is referred to as a front side and a far side is referred to as a back side in FIG. 1.

As illustrated in FIG. 1, the printer 11 includes a cuboid body case 12. The body case 12 includes a unreeling section 14 which unreels a long sheet 13, a print chamber 15 which performs printing on the sheet 13 by ejecting ink, a drying device 16 which performs a drying process on the sheet 13 to which the ink is attached by the printing, and a reeling section 17 which reels the sheet 13 which has been subjected to the drying process.

A flat plate base 18 which separates the body case 12 into an upper side and a lower side is disposed in an upper portion relative to a center of the body case 12. An upper region relative to the base 18 is the print chamber 15 including a support member 19 of a rectangle bar shape supported on the base 18. A lower region relative to the base 18 includes the unreeling section 14 on a left side which is an upstream in a direction in which the sheet 13 is transported and the drying device 16 and the reeling section 17 on a right side which is a downstream.

As illustrated in FIG. 1, the unreeling section 14 includes a winding shaft 20 extending in a front-back direction in a rotatable manner, and the sheet 13 is supported by the winding shaft 20 in an integrally rotatable manner in a state in which the sheet 13 is wound as a roll. The sheet 13 is unreeled from the unreeling section 14 when the winding shaft 20 rotates. Furthermore, the sheet 13 unreeled from the unreeling section 14 is hung on a first roller 21 disposed on a right side of the winding shaft 20.

On the other hand, a second roller 22 is disposed in a position on a left side of the support member 19 and corresponding to the first roller 21 disposed on a lower side of the second roller 22 in the vertical direction. The second roller 22 is disposed in parallel to the first roller 21. Then the sheet 13 transported in a vertically upward direction by the first roller 21 is hung on the second roller 22 from a lower left portion of the second roller 22 so that the transport direction of the sheet 13 is changed to a horizontally rightward direction and the sheet 13 slides on an upper surface of the support member 19.

Furthermore, a third roller 23 which faces the second roller 22 on the left side with the support member 19 interposed therebetween is disposed on a right side of the support member 19 in parallel to the second roller 22. Note that positions of the second roller 22 and the third roller 23 are adjusted such that top portions of peripheries of the second roller 22 and the third roller 23 are the same as a top surface of the support member 19 in height.

The sheet 13 which has been transported rightward in the horizontal direction by the second roller 22 disposed on the left side in the print chamber 15 is transported to the right side which is the downstream while sliding the upper surface of the support member 19, and thereafter, the sheet 13 is hung on the third roller 23 from an upper right side so that a transport direction is changed to a vertically downward direction so as to be transported to the drying device 16 disposed on the lower side relative to the base 18. Thereafter, the sheet 13 which has been subjected to the drying process in the drying device 16 is further transported downward in the vertical direction, and hung on a fourth roller 24 so that the transport direction is changed to a horizontally right direction. Thereafter, the sheet 13 is reeled in a roll shape when a winding shaft 25 of the reeling section 17 disposed on a right side of the fourth roller 24 is rotated. The winding shaft 25 is rotated by driving forth of a transport motor not illustrated.

As illustrated in FIG. 1, guide rails 26 extending in the horizontal direction are included in the print chamber 15. The guide rails 26 are disposed on front and back sides of the support member 19 in the print chamber 15 as a pair. Upper surfaces of the guide rails 26 are higher than the upper surface of the support member 19. A rectangle carriage 27 is supported on the upper surfaces of the guide rails 26 in a state in which the rectangle carriage 27 is available for reciprocation in a main scanning direction X illustrated in FIG. 1 along the guide rails 26 in accordance with driving of first and second carriage motors. A plurality of heads 29 are supported on a lower surface of the rectangle carriage 27 through a support plate 28.

A certain range from a left end to a right end of the support member 19 is determined as a print region, and the sheet 13 is intermittently transported in a unit of print region. Printing is performed on the sheet 13 when ink is ejected from the print heads 29 in accordance with reciprocation of the carriage 27 relative to the sheet 13 stopped on the support member 19.

Note that, when the printing is performed, a suction device 30 disposed beneath the support member 19 is driven so that the sheet 13 is sucked on the upper surface of the support member 19 by sucking force caused by negative pressure applied over a large number of sucking holes which are opened on the upper surface of the support member 19. After the one printing operation on the sheet 13 is terminated, the negative pressure of the suction device 30 is released and the sheet 13 is transported.

Furthermore, a maintenance device 32 for performing maintenance on the heads 29 at the time of printing is disposed in a non-printing region on a right side relative to the third roller 23 in the print chamber 15. The maintenance device 32 includes caps 33 for individual recording heads 29 and a lifting device 34. The caps 33 move between a capping position where the caps 33 abut on nozzle forming surfaces 35 of the recording heads 29 and a retracting position where the caps 33 are separated from the nozzle forming surfaces 35 when the lifting device 34 is driven. The nozzle forming surfaces 35 will be described with reference to FIG. 2.

Furthermore, as illustrated in FIG. 1, a plurality of ink cartridges IC1 to IC8 which accommodate different colors of ink are installed in the body case 12 in a detachable manner. Note that the number of ink cartridges is not limited to eight. The ink cartridges IC1 to IC8 are coupled to the recording heads 29 through ink supply paths, and the individual recording heads 29 eject the ink supplied from the corresponding ink cartridges IC1 to IC8. The ink supply paths will be described hereinafter with reference to FIG. 2. The printer 11 illustrated in FIG. 1 is capable of performing color printing using eight color inks. Note that opening/closing covers 38 are disposed in portions corresponding to portions of the ink cartridges IC1 to IC8 in the body case 12. The ink cartridges IC1 to IC8 are replaced by opening the covers 38.

The eight ink cartridges IC1 to IC8 accommodate inks of black, cyan, magenta, yellow, and so on, for example. Note that a moisture liquid cartridge which accommodates moisture liquid may be attached. Types of ink and the number of colors of ink may be appropriately set. Only black ink may be used as monochrome printing, only two colors of ink may be used, or an arbitrary number of colors of ink which is three or more colors and which is other than eight colors may be used.

The individual ink cartridges IC1 to IC8 are electrically coupled to the control device C through cartridge holders, not illustrated, and information on amounts of remaining inks of the corresponding colors are written in nonvolatile storage elements implemented in the ink cartridges IC1 to IC8.

FIG. 2 is a diagram schematically illustrating the plurality of recording heads 29 disposed on a bottom surface of the carriage 27 and an ink supply device 39 which supplies ink to the individual recording heads 29. As illustrated in FIG. 2, the plurality of recording heads 29 are supported by the support plate 28 which is supported on a lower surface of the carriage 27 such that the recording heads 29 are arranged in a zig-zag pattern in a width direction which is orthogonal to a transport direction of the sheet 13. Specifically, recording heads 29A and recording heads 29B which are 15 recording heads 29 in total are arranged in respective two lines at a regular pitch in a sub-scanning direction Y while being shifted from each other by a half pitch in the sub-scanning direction Y. Then a plurality of nozzle lines 37 are formed in a main-scanning direction X with a certain interval on the nozzle forming surfaces 35 which are lower surfaces of the recording heads 29. Each of the nozzle lines 37 includes a plurality of nozzles 36 arranged in a line in the sub-scanning direction Y. Although eight nozzle lines 37 are arranged, for example, the number of nozzle lines is not limited to this.

As illustrated in FIG. 2, the printer 11 includes an ink supply device 39 which supplies inks of the various colors to the individual recording heads 29. The ink supply device 39 includes a pump motor 65, a pressure pump 66, the ink cartridges IC1 to IC8, and sub-tanks 67.

When being attached to the cartridge holders, the ink cartridges IC1 to IC8 are coupled to the corresponding sub-tanks 67 through ink supply paths 70A, and the sub-tanks 67 are further coupled to the recording heads 29 through ink supply paths 70B. The ink supply paths 70A and the ink supply paths 70B are tubes, for example. Note that only the coupling relationship between the plurality of sub-tanks 67 and one of the recording heads 29 is illustrated in FIG. 2. A number of ink supply paths 70B corresponding to the number of recording heads 29 extend from each of the sub-tanks 67, and the ink supply paths 70B extending from each of the sub-tanks 67 are coupled to the corresponding recording heads 29.

Furthermore, the ink cartridges IC1 to IC8 are coupled to a discharge port of the pressure pump 66 through an air supply path 71 in a state in which the ink cartridges IC1 to IC8 are attached to the cartridge holders. When a control device C drives the pump motor 65 so as to drive the pressure pump 66, pressurized air discharged from the pressure pump 66 is supplied to the ink cartridges IC1 to IC8 through the air supply path 71.

An ink pack is accommodated in each of the ink cartridges IC. When the ink pack is pressurized by the pressurized air supplied to the ink cartridge IC through the air supply path 71, ink is supplied from the ink cartridge IC to a corresponding one of the ink supply paths 70A in a pressurized manner. The ink supplied from the ink cartridges IC are supplied to the sub-tanks 67 through the respective ink supply paths 70A and further supplied to the recording heads 29 from the sub-tanks 67 through the ink supply paths 70B.

FIG. 3 is a diagram schematically illustrating the information collecting system 400. The print system 300 is configured in facility of a company which has purchased the printer 11, for example, and is described above with reference to FIG. 1 in detail. Note that the print system 300 illustrated in FIG. 1 includes one printer 11 and one image generation apparatus 310. However, the print system 300 may include a plurality of printers 11 and a single image generation apparatus 310 which is shared by the plurality of printers 11. As illustrated in FIG. 3, the number of the print systems 300 is not limited to one and a plurality of print systems 300 may be used. Furthermore, a configuration of a system including the information collecting system 400 is not limited to that illustrated in FIG. 3, and various modifications may be made such that some of the components are omitted or other components are added, for example.

The print system 300 collects error information and operation information of the printer 11. The error information is associated with an error which occurs in the printer 11. Examples of the error which occurs in the printer 11 include ejection failure of heads, liquid leakage, a motor error, and a substrate error. The ejection failure is also referred to as clogging of the nozzles 36 included in the recording heads 29. The liquid leakage is specifically leakage of ink. The error information includes information specifying a type of generated error and information representing a date and time of occurrence of an error. The printer 11 includes a detection plate and a sensor which detects whether ink has been ejected to the detection plate. The printer 11 outputs error information indicating ejection failure based on an output of the sensor. When the recording heads 29 eject ink using piezoelectric elements, different waveforms of current are generally supplied to the piezoelectric elements in different examples, that is, an example in which ink is appropriately ejected and an example in which ink is not appropriately ejected. Therefore, the printer 11 may output error information indicating ejection failure based on a waveform current. Furthermore, the printer 11 includes a liquid leakage detection sensor which outputs error information indicating liquid leakage based on an output of the liquid leakage detection sensor. Various methods for detecting error information in the printer 11 are generally used and are widely applicable in this embodiment.

The operation information indicates an operation state of the printer 11. Examples of the operation information include job history information indicating a history of print jobs which have been executed, event history information indicating a history of events generated in the printer 11, ink consumption amount information, print amount information, nozzle information, and information on lifetimes of consumables.

The print job is data corresponding to one printing operation performed by the printer 11. The job history information is time-series data obtained by associating information on an executed print job and information on a date and time of the execution with each other. The information indicating a print job includes a job ID, information specifying image data to be printed, and the like. The information specifying image data may be image data itself, data indicating a thumbnail image, information on a file name, or the like.

Events are generated in the printer 11, such as nozzle check, cleaning, and flushing. The event history information is time-series data obtained by associating information on a generated event and information on a date and time of the generation with each other.

The ink consumption amount information indicates an amount of ink consumed by printing performed by the printer 11. The ink consumption amount is obtained by multiplying the number of times ink is ejected from the nozzles 36 of the recording heads 29 by an amount of ink used for the single ejection operation, for example. Furthermore, the printer 11 includes a sensor for detection of an ink amount, and an ink consumption amount may be calculated based on an output of the sensor.

The print amount information indicates an amount of printing medium consumed by the printing performed by the printer 11. When a printing medium is the rolled sheet 13 as described above, for example, the print amount information indicates a length of the sheet 13 used for the printing. Note that the print amount information may be information indicating an area of a printing medium used for the printing or information indicating the number of printing media.

The information on lifetimes of consumables indicates degrees of use of consumables. Here, the consumables are maintenance components or replaceable components included in the printer 11 which are preferably replaced in a periodic manner. Examples of the consumables include various components, such as print heads, flow path filters, tubes, a transport motor, and a carriage motor. The print heads are specifically the recording heads 29. The tubes are specifically the ink supply paths 70A and 70B. The tubes may include discharge liquid tubes which discharge ink to discharge liquid tanks. The flow path filters remove foreign matters contaminated in the ink supply paths 70A and 70B. The components have upper limits of use amounts so as to be designed for good predetermined performance. Here, the use amounts may be use times or the number of times the components are used. Furthermore, the use amounts may be movement amounts or rotation amounts for movable components such as a motor. The use times of consumables may be a period of time in which the printer 11 is in active or a period of time in which a print job is executed, for example. Furthermore, use amounts of individual consumables may be counted by different methods, and various modifications may be made as concrete methods for obtaining use amounts. The information on lifetimes of consumables indicates rates of actual use amounts to upper limits of use amounts of target consumables, for example.

The information collecting system 400 includes a server system 410 and a terminal device 420. The server system 410 and the terminal device 420 are connected to a network NE2 and may be communicated with each other through the network NE2 in a bidirectional manner. The network NE2 is a public communication network, such as the Internet. Note that the server system 410 and the terminal device 420 may be connected to each other through a private network, not illustrated, which is different from the network NE2 which is a public communication network. Examples of the private network include intranets in companies, for example.

The print system 300 and the server system 410 are connected to the network NE2 and may be communicated with each other through the network NE2 in a bidirectional manner. The server system 410 collects error information and operation information of the printer 11 from the print system 300 through the network NE2. For example, the image generation apparatus 310 performs a process of collecting error information and operation information from the printer 11 and a process of transmitting the collected error information and the collected operation information to the server system 410. Note that the printer 11 or the host apparatus 320 may perform the collecting process or the transmitting process.

Furthermore, the terminal device 420 is a terminal used by a service person who performs maintenance or repair of the printer 11, for example. The terminal device 420 may be a personal computer (PC) or a mobile terminal apparatus, such as a tablet terminal. When performing a countermeasure, such as repair or inspection, on the printer 11 of which the service person is in charge, the service person generates report information on the countermeasure. The terminal device 420 transmits the report information generated by the service person to the server system 410.

The report information include, for example, information specifying the printer 11 subjected to the countermeasure, the error information output from the printer 11, information indicating the countermeasure performed by the service person, and information indicating a result of the countermeasure. The information specifying the printer 11 includes a printer ID uniquely specifying the printer 11, information on a model of the printer 11, and version information of firmware of the printer 11. The printer ID is a serial number described below, for example. The error information is output from the printer 11 before the countermeasure. The report information may include, in addition to the error information, information on a trouble reported by a customer using the printer 11. The trouble includes a blur or bleeding of a result of printing and a color which is different from a set color which are recognized by the customer. Examples of the information on a countermeasure include information indicating replacement of consumables and information on thorough cleaning which is performed by the service person. The result of countermeasure is information indicating whether restoration to a normal state is attained by the countermeasure.

Note that a plurality of terminal devices 420 may be used. For example, different service persons perform maintenance of different printers 11. The different service persons generate and transmit report information using different terminal devices 420. Alternatively, a single service person may use a plurality of terminal devices 420.

As described above, the server system 410 accumulates information on the printer 11 by collecting the error information, the operation information, and the report information. The server system 410 performs processing on the collected information and transmits the processed information to the print system 300 and the terminal device 420. Examples of the processing include a process of extracting specific information, a statistical process, and a process of generating a graph. Note that the transmission of information from the server system 410 may be performed as a response to a request transmitted from the print system 300 or the terminal device 420 or may be performed by push notification.

The server system 410 generates information for a customer which is useful when the customer uses the printer 11, such as ink use amount data in time-series and information on a history of executed jobs and transmits the information for a customer to the print system 300. The transmitted information for a customer is displayed in the monitor 314 of the image generation apparatus 310 or the monitor 323 of the host apparatus 320, for example. Furthermore, the apparatus which receives the information for a customer is not limited to the apparatus included in the print system 300 and may be another apparatus used by the customer.

Furthermore, the server system 410 generates information for a service person which is useful for the service person maintaining the printer 11, such as an error occurrence history, information indicating lifetimes of consumables, and a repair history, and transmits the information for a service person to the terminal device 420. Note that the information for a customer and the information for a service person may include the same information. Furthermore, a terminal which receives the information for a service person is not limited to the terminal device 420 and may be another terminal device used by a service person. In other words, the terminal which transmits the report information to the server system 410 and the terminal which receives the information for a service person may be the same or may be different.

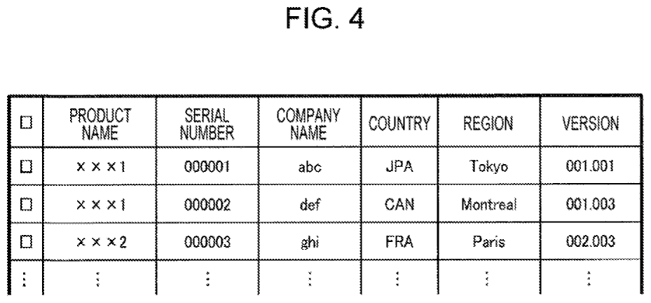

For example, the server system 410 transmits the collected error information to the terminal device 420. An example of a screen for browsing the error information in the terminal device 420 will be described with reference to FIGS. 4 to 6.

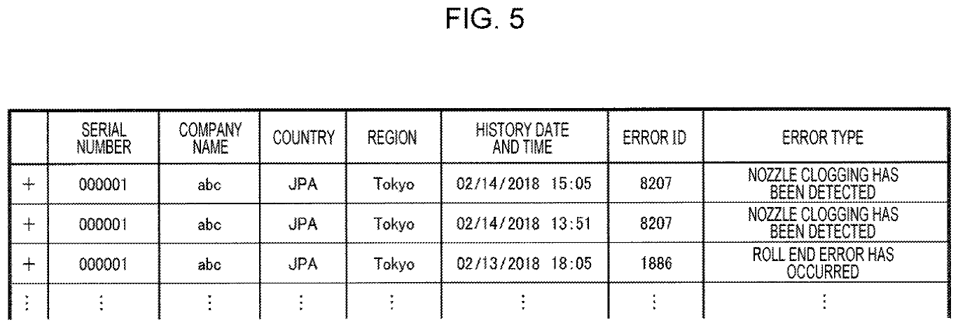

FIG. 4 is a diagram illustrating an example of a display screen for browsing information on the printer 11, and specifically, an example of a home screen. For example, the server system 410 includes a database server which stores the error information, the operation information, and the report information and a web application server. The web application server obtains required information from the database server based on a request transmitted from the terminal device 420 and transmits a HyperText Markup Language (HTML) file including the error information and the operation information as a response. FIG. 4 and FIG. 5 described hereinafter illustrate screens displayed using a web browser operating in the terminal device 420, for example.

As illustrated in FIG. 4, the information displayed in the home screen includes a product name of the printer 11, a serial number, a company name, a country, a region, and a version. The product name indicates a model number of the printer 11. The serial number indicates an ID which uniquely identifies the printer 11. The company name indicates a name of a company of a customer. The country and the region indicate a place where the target printer 11 operates. The version indicates a version of firmware of the printer 11. Use of the screen in FIG. 4 enables the service person to recognize the information on the printers 11 installed all over the world in a mode of high listing property.

FIG. 5 is a diagram illustrating an example of a display screen for browsing the error information associated with a given printer 11. For example, when an operation of selecting the given printer 11 and an operation of instructing display of error information are performed in the screen illustrated in FIG. 4, the display is changed to the screen illustrated in FIG. 5. Note that the operation of selecting the printer 11 is performed in the screen illustrated in FIG. by pressing a selection button, not illustrated, after checking one of checkboxes in a left end in FIG. 4, for example. Only a single printer 11 may be selected or a plurality of printers 11 may be selected.

As illustrated in FIG. 5, the information displayed in an error screen includes a serial number, a company name, a country, a region, a history date and time, an error ID, and an error type. The serial number, the company name, the country, and the region are the same as those in FIG. 4. The history date and time indicates information on a date and time when an error has occurred. The error ID specifies a generated error. The error type is text information indicating a generated error. The use of the screen illustrated in FIG. 5 enables the service person to recognize a type of an error and a timing when the error has occurred in the printer 11 in which the service person takes charge of maintenance.

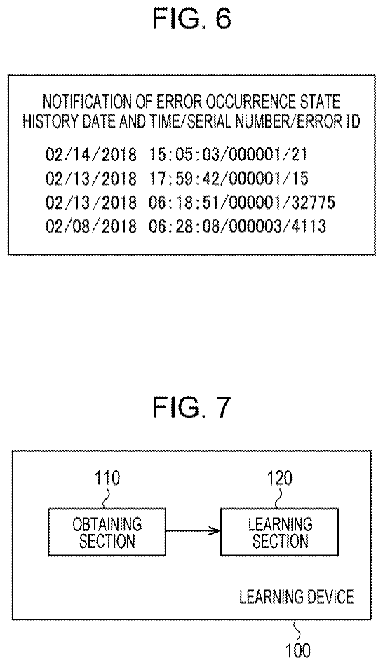

FIG. 6 is a diagram illustrating a portion of an error notification mail transmitted to the terminal device 420 used by the service person. As illustrated in FIG. 6, the error notification mail includes a history date and time, a serial number, and an error ID. Content of the information is the same as that in FIG. 5. In the general methods, the server system 410 transmits the error notification mail including the content illustrated in FIG. 6 to the terminal device 420 every predetermined period, for example. The information included in the error notification mail is associated with an error which has occurred in the predetermined period. The predetermined period corresponds to approximately several hours or one day, for example. Furthermore, although the example in which the error notification mail is used is described in this embodiment, the server system 410 may transmit the information illustrated in FIG. 6 to the terminal device 420 using another push notification method.

When the screen illustrated in FIG. 5 is used, the service person actively obtains error information. Specifically, the service person actively executes an operation of displaying the error screen using the operation section of the terminal device 420. When the error notification mail illustrated in FIG. 6 is used, the service person passively obtains the error information. By any method, the service person may recognize occurrence of an error in the printer 11 in which the service person takes charge of maintenance when the server system 410 transmits the error information to the terminal device 420.

Furthermore, the server system 410 accumulates report information as described above. The accumulated report information includes countermeasures against past errors and results of performance of the countermeasures. The service person determines a countermeasure for resolution of the error generated in the printer 11 in which the service person takes charge of maintenance with reference to the report information.

However, in the general methods, it is not easy for a service person to determine an appropriate countermeasure against an error. This is because a plurality of countermeasures may resolve a given error. For example, an error may be resolved when cleaning is performed on an error which is an ejection failure, or the error may not be resolved unless nozzles are exposed by disassembling and cleaned by wiping. When a degree of clogging is serious, the error may not be resolved unless the print heads are replaced. The print heads are specifically the recording heads 29. The report information includes information on resolution of the ejection failure by cleaning, information on resolution of the ejection failure by wiping cleaning, information on resolution of the ejection failure by replacement of the print heads, and the like. Therefore, in the general methods, the service person is required to determine report information to be referred to. Consequently, execution of an appropriate countermeasure depends on knowledge and experience of the service person.

It may be highly likely that the error is resolved when the service person attempts all possible countermeasures in a brute-force manner after actually being moved to a place where the print system 300 is installed. However, it is difficult to perform such a process to the industrial printer illustrated in FIGS. 1 and 2. First, the industrial printer described above is considerably large and has a complicated configuration, and therefore, a period of time required for disassembling and replacing components is long when compared with printers for consumers which are widely used. For example, it is expected that several hours is required or more than ten hours is required in some cases for one countermeasure, and therefore, temporal cost becomes large when all the plurality of countermeasures are individually attempted in the brute-force manner. In industrial printers, when the operation of the printer 11 is stopped due to an error, and therefore, a downtime is generated, production of a product is stopped. The generation of a downtime results in deterioration of productivity, and therefore, repair which takes long time is not preferable.

Furthermore, components to be replaced in the industrial printers are larger and heavier than those of the printers for consumers. Therefore, the number of replacement components to be prepared for a countermeasure is increased and transport of the replacement components are difficult unless the number of countermeasures to be employed is reduced. Furthermore, the number of tools required for replacement of components is also increased. The components and tools may not be put on a vehicle for traveling used by the service person depending on circumstances.

Furthermore, there may also arise a problem in that the industrial printers are delivered all over the world. For example, it may take one day or several days from a service base where the service person resides to an office of a customer. When an error is not resolved by an estimated countermeasure, the service person takes a long time to return to the service base, prepares components and tools for another countermeasure, and takes a long time again to move to the office of the customer. In this case, it is likely that the operation of the printer 11 is stopped for a long period of time.

Note that it is highly probable that the error is resolved when the print heads are replaced in the example of the ejection failure. However, the print heads have complicated configurations having the large number of nozzles 36 and cost of the print heads is high. Furthermore, temporal cost is also high since the number of components to be detached by disassembling to expose the print heads is large. Specifically, when a countermeasure which resolves the ejection failure without replacing the print heads is applicable, the countermeasure is preferentially performed, and a general countermeasure which is suitable for all circumstances is difficult to be expected.

Although it is important to narrow down the number of countermeasures which are highly probable that the error is resolved as described above, it is difficult to determine an appropriate countermeasure only with reference to past report information. JP-A-2008-211662 discloses a method for referring to a database including status information. However, when the general method disclosed in JP-A-2008-211662 is used, a user is required to set a condition for coupling numerical values of status information and concrete countermeasures for individual countermeasures. When the user attempts to set appropriate conditions for all possible countermeasures, a burden of the user is increased. Furthermore, when an error occurs under a new circumstance which is not similar to past examples, an appropriate countermeasure against the error may not be proposed.

Therefore, in this embodiment, a condition of a countermeasure recommended for error information is mechanically learnt. By this, a recommended countermeasure is automatically learnt, and therefore, an appropriate countermeasure may be proposed to the user, that is, the service person. For example, degrees of seriousness of errors may be individually determined using various operation information as input data even when the errors are the same type, and therefore, an appropriate countermeasure may be proposed. In this case, the user is not required to manually set a concrete determination condition, and therefore, a burden of the user may be reduced.

Furthermore, in the foregoing description, the example in which the user to which the recommended countermeasure is to be proposed is the service person who takes in charge of maintenance of the electronic apparatus is described. However, the recommended countermeasure may be proposed to a customer, that is, a user of the electronic apparatus. For example, the customer may be prompted to perform a simple countermeasure which does not require special tools and which is not dangerous. Hereinafter, an example in which a countermeasure is proposed to a user who is a service person by transmitting error information to the terminal device 420 will be described. Note that the term “user” described below may be replaced by a “user who is a customer” where appropriate. Furthermore, a transmission destination of the error information is not limited to the terminal device 420 and may be the print system 300 used by the customer or an apparatus, not illustrated.

Hereinafter, a learning process and an estimation process of this embodiment will be individually described. The learning process obtains a learning result by performing machine learning based on training data. The learning result is specifically a machine-learned model. The estimation process outputs an estimation result of some sort based on an input using the machine-learned model generated by the learning process. Furthermore, a method for updating the machine-learned model based on a result of the estimation process will also be described.

### 2. Learning Process

### 2.1 Example of Configuration of Learning Device

FIG. 7 is a diagram illustrating an example of a configuration of a learning device 100 of this embodiment. The learning device 100 includes an obtaining section 110 which obtains training data used for leaning and a learning section 120 which performs machine learning based on the training data.

The learning device 100 illustrated in FIG. 7 is included in the server system 410 of FIG. 3, for example. Specifically, the server system 410 performs a process of obtaining training data from the print system 300 and the terminal device 420 and a process of performing machine learning based on the training data. Note that the learning device 100 may be included in an apparatus except for the server system 410. For example, the learning device 100 is included in an apparatus coupled to the server system 410 through the network NE2. The apparatus obtains training data collected by the server system 410 through the network NE2 and performs machine learning based on the training data. Alternatively, the learning device 100 may obtain training data from the server system 410 through another apparatus. Alternatively, training data may be accumulated in a system other than the information collecting system 400 of FIG. 3.

The obtaining section 110 is a communication interface which obtains training data from another device, for example. Alternatively, the obtaining section 110 may obtain training data stored in the learning device 100. For example, the learning device 100 includes a storage section, not illustrated, and the obtaining section 110 is an interface for reading training data from the storage section. The learning in this embodiment is supervised learning, for example. The training data in the supervised learning is a data set in which input data and a correct label are associated with each other. The correct label may be reworded as supervised data.

The learning section 120 performs machine learning based on training data obtained by the obtaining section 110 so as to generate a machine-learned model. Note that the learning section 120 of this embodiment is configured by hardware below. The hardware may include at least one of a circuit which processes a digital signal and a circuit which processes an analog signal. For example, the hardware may be configured by one or more circuit devices which are implemented in a circuit substrate or one or more circuit elements implemented in the circuit substrate. The one or more circuit devices are integrated circuits (ICs), for example. The one or more circuit elements are resistances or capacitors, for example.

Furthermore, the learning section 120 may be realized by a processor described below. The learning device 100 of this embodiment includes a memory which stores information and the processor which operates based on the information stored in the memory. The information includes programs and various data, for example. The processor includes hardware. Various types of processor, such as a CPU, a graphics processing unit (GPU), and a digital signal processor (DSP), may be used as the processor. Examples of the memory include a semiconductor memory, such as a static random access memory (SRAM) or a dynamic random access memory (DRAM), a register, a magnetic storage device, such as a hard disk device, or an optical storage device, such as an optical disc device. For example, the memory stores computer readable instructions, and when the processor executes the instructions, functions of the sections included in the learning device 100 are realized as processes. Examples of the instructions include an instruction of an instruction set included in a program and an instruction for instructing an operation of a hardware circuit of the processor.

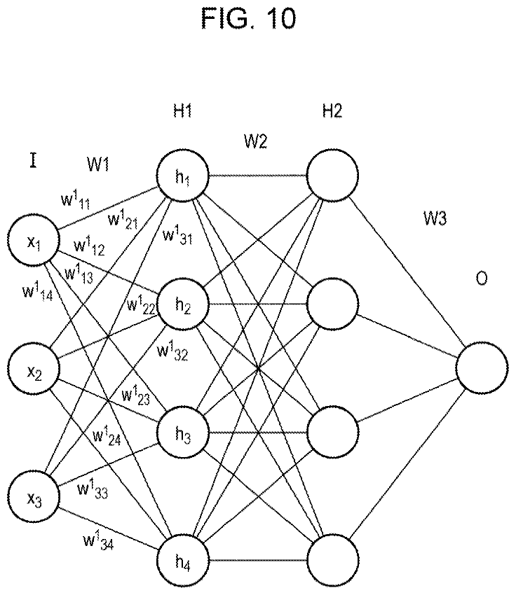

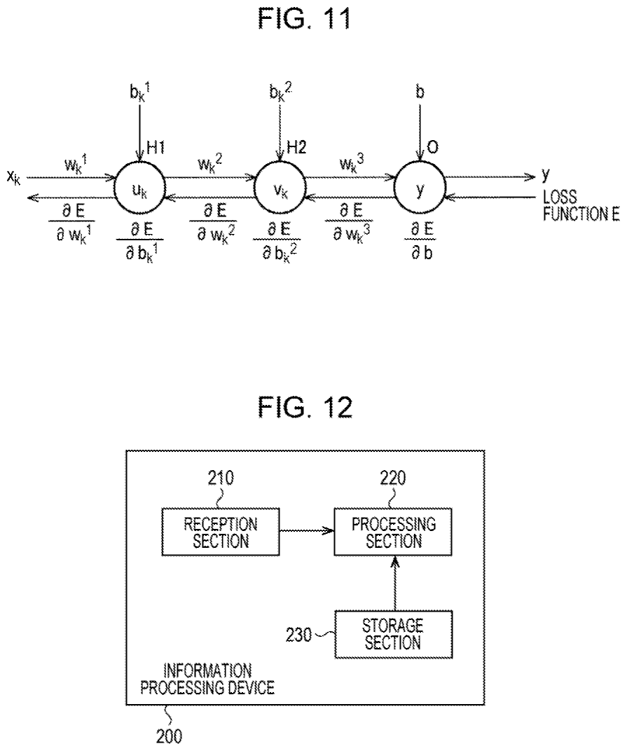

Specifically, the obtaining section 110 obtains error information indicating an error generated in the electronic apparatus, operation information indicating an operation state of the electronic apparatus, and countermeasure information indicating a countermeasure performed against the error. The error information and the operation information have been described above. The countermeasure information is a portion of the report information or the entire report information and includes information specifying the printer 11 which has been subjected to the countermeasure, information indicating the countermeasure performed by the service person, and information indicating a result of the countermeasure. The learning section 120 mechanically learns a condition of a recommended countermeasure against the error indicated by the error information based on a data set in which the error information, the operation information, and the countermeasure information are associated with one another. By this, a result of learning is obtained taking the relationships between past errors and countermeasures performed against the errors into consideration. A countermeasure which is highly possible to resolve the error may be proposed to the user by means of the learning result. For example, when the large printer 11 illustrated in FIGS. 1 and 2 is used, the number of appropriate countermeasures may be narrowed down, and therefore, replacement components required for the countermeasure may be prepared and repair cost and a period of time required for the repair may be reduced. A flow of the learning process will be described in detail hereinafter with reference to FIGS. 10 and 11.

### 2.2 Example of Data Set Used in Learning Process

As described above, the training data used in the learning process in this embodiment is a data set in which the error information, the operation information, and the countermeasure information are associated with one another.

The error information indicates an error associated with consumables used in the electronic apparatus. The countermeasure includes replacement of the consumables and maintenance of the consumables. As described above, the consumables deteriorates with use of the electronic apparatus, and therefore, are to be maintained and replaced by the user. The consumables in the printer 11 include the print heads, the tubes, and the various motors. When the electronic apparatus is a projector, the consumables includes a light source. Components serving as the consumables are different according to a type of the electronic apparatus. In this way, since the error information associated with the consumables is processed, a countermeasure appropriate for the consumables may be performed by the user. Furthermore, according to the method of this embodiment, a determination as to whether the consumables are replaced or the existing consumables are maintained may be appropriately made. For example, only the maintenance of the consumables is performed as long as an error is resolved, and the consumables are replaced only when the replacement is required as a countermeasure. Therefore, when the electronic apparatus is to be used for a long period of time, reduction of running cost may be realized.

For example, the electronic apparatus is the printer 11 and the consumables are the print heads. The error is clogging of the nozzles 36 of the print heads. By this, when ejection failure of the print heads occurs, a countermeasure for resolving the ejection failure may be appropriately determined. For example, the printer 11 illustrated in FIGS. 1 and 2 has the plurality of recording heads 29, and each of the recording heads 29 has a large number of nozzles 36. Therefore, the error referred to as the ejection failure may frequently occur.

However, the ejection failure may be resolved by flushing or cleaning periodically executed by the printer 11 or powerful cleaning may be required to be performed by the user who is the service person executing a dedicated command to resolve the ejection failure. Alternatively, physical cleaning may be required on portions in the vicinity of the nozzles 36 after the printer 11 is disassembled or the print heads themselves may be required to be replaced when serious clogging has occurred. Note that the term “flushing” indicates ejection of ink from the individual nozzles 36 performed independently from the printing. The term “cleaning” indicates cleaning inside the print heads by sucking the print heads using a pump or the like disposed in a discharge ink box without driving the print heads.

As described hereinabove, various countermeasures are executable against the ejection failure although the ejection failure is an error which occurs with comparatively high frequency. Therefore, it is not easy to determine a countermeasure for resolving an error state while temporal cost or production cost are suppressed. Accordingly, learning of an appropriate countermeasure using the machine learning is greatly significant.

Alternatively, the electronic apparatus is the printer 11 and the consumables are the tubes which are ink supply paths used for the printing and the pump used for supply of ink. The error indicates liquid leakage, that is, leakage of ink. The tubes are specifically the ink supply paths 70A and 70B illustrated in FIG. 2, for example. The pump is the pressure pump 66 illustrated in FIG. 2, for example. Alternatively, when ink is supplied by sucking, the pump may be a suction pump. Furthermore, the term “supply” here is not limited to the supply of ink from the ink cartridges and the ink tanks to the print heads and includes discharge of ink from the print heads to the discharge liquid tanks and the like. Specifically, the tubes may include discharge liquid tubes which move ink included in the print heads to the discharge liquid tanks. Furthermore, the suction pump is used to discharge ink to the discharge liquid tanks, for example.

By this, when liquid leakage occurs in the printer 11, a countermeasure for resolving the liquid leakage may be appropriately determined. When the liquid leakage occurs, the ink which is liquid is likely to spread inside the printer 11, and therefore, the liquid leakage may lead failure of the other components, for example. Moreover, when the liquid leakage occurs in a portion in the vicinity of one of the print heads, the sheet 13 may be contaminated and appropriate production of a product may become difficult. Accordingly, the liquid leakage is an error to be quickly resolved. However, as described with reference to FIG. 2, a large number of tubes are disposed in the printer 11 in a complicated manner, and therefore, various factors of occurrence of liquid leakage and various appropriate countermeasures may be considered. Since it is not easy to determine a countermeasure which resolves the error state of the liquid leakage as described above, learning of an appropriate countermeasure using the machine learning is greatly significant.

Furthermore, the learning process of this embodiment uses the operation information as input data. The operation information includes information on lifetimes of consumables, for example. The lifetime information has been described above. When lifetimes of the print heads are expired, that is, when the print heads are used over expected lifetimes, it is estimated that deterioration of the print heads has progressed. Therefore, it is difficult to resolve an error by the flushing or the cleaning, and it is highly probable that the print heads are required to be replaced as a countermeasure. On the other hand, when the print heads are almost new, it is highly probable that the ejection failure is resolved by wiping or cleaning instead of a high-cost countermeasure, such as the replacement of the print heads. Specifically, a countermeasure may be estimated taking a state of the printer 11 into consideration using the operation information which reflects an operation state of the printer 11 for the learning process.

Furthermore, the operation information includes information on a use history of the consumables or information on a history of jobs using the consumables. Even when use times of the consumables are the same, different deterioration degrees of consumables may be obtained in different examples, that is, an example in which the consumables are used for 8 hours a day and are not used for remaining 16 hours and an example in which the consumables are continuously used for 24 hours. Specifically, when deterioration of the consumables are to be determined, not only simple accumulated use time but also a history of use is preferably used. Furthermore, the job history information indicates a type of a print job, a timing when the print job has been input, and a timing when the print job has been executed. When content of the job is determined, a use state of the consumables is also determined, and therefore, a history of use of the consumables may be estimated also using the job history information. In this way, since detailed information on the consumables is used in the learning process, an appropriate countermeasure may be learnt with high accuracy.

Furthermore, other information included in the operation information may be used as input data in the learning process. For example, the learning device 100 may use ink consumption amount information, print amount information, event information, and the like as the input data.

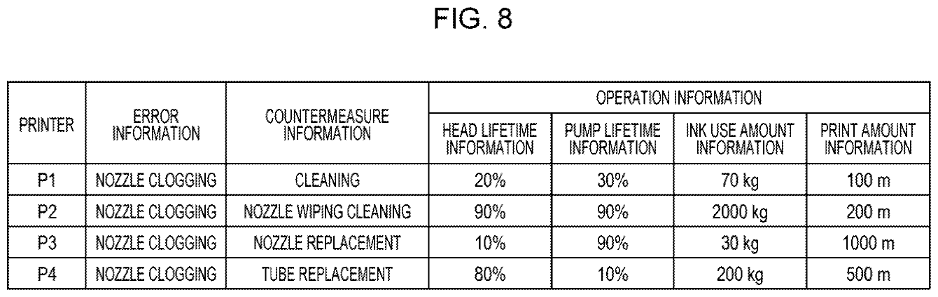

FIG. 8 is a diagram illustrating examples of data sets when ejection failure occurs as an error. The data sets which are training data are obtained by associating error information, past countermeasures, and operation information obtained when errors occur with one another.

The error information is transmitted from the print system 300. For example, the learning device 100 uses information specifying a type of an error included in the error information as the training data. As illustrated in FIG. 8, a type of error specified by the error information is ejection failure or nozzle clogging.

The countermeasure information is included in the report information transmitted from the terminal device 420. For example, the learning device 100 uses information specifying a type of countermeasure which attains resolution of an error included in the report information as the training data. For example, the server system 410 lists possible countermeasures of the electronic apparatus and assigns identification information to the individual countermeasures. Here, the identification information indicates a countermeasure ID which uniquely specifies a countermeasure, for example. The report information includes the countermeasure ID, and the learning device 100 determines the countermeasure ID as the training data. Note that the countermeasure information is not limited to a countermeasure which has resolved an error. For example, the countermeasure information may be information obtained by associating an executed countermeasure and a result of a determination as to whether an error has been resolved by the countermeasure with each other. In other words, the countermeasure information may include information indicating an inappropriate countermeasure which does not resolve an error.

The operation information includes information on lifetimes of the print heads, information on a lifetime of the pump, information on an ink use amount, and information on a print amount. In this way, learning accuracy may be improved when operation information which may highly relate to the ejection failure is determined as the training data. Note that the operation information used for the training data is not limited to the example of FIG. 8, and a portion may be omitted or other operation information may be added.

Note that, as illustrated in FIG. 8, the data sets may include information identifying the printer 11 in which an error has occurred. The information identifying the printer 11 is denoted by a serial number described above, for example. Alternatively, instead of the identification of a printer, information on a model type or version information of firmware may be used as the information identifying the printer 11.

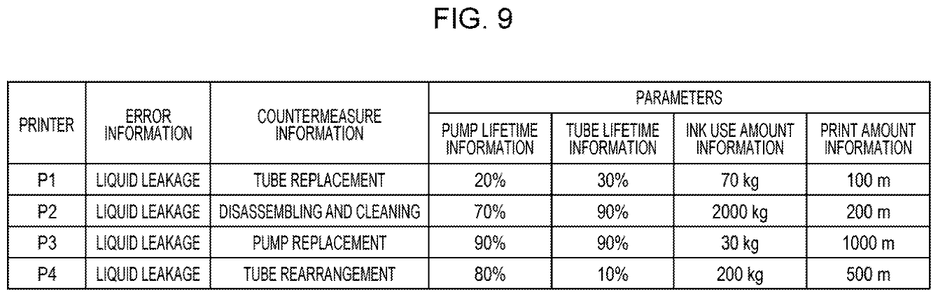

FIG. 9 is a diagram illustrating examples of data sets when liquid leakage occurs as an error. As with the case of FIG. 8, the data sets which are training data are obtained by associating error information, past countermeasures, and operation information obtained when errors occur with one another. Furthermore, as with the case of FIG. 8, the data sets may include information identifying the printer 11.

The error information is the same as that of FIG. 8, and error information transmitted from the print system 300 is used. However, an error indicated by error information is liquid leakage in the example of FIG. 9.

Furthermore, the countermeasure information is the same as that of FIG. 8 which specifies a type of countermeasure included in the report information. Note that different candidates of countermeasure are obtained for the ejection failure and the liquid leakage. Examples of the countermeasure against the liquid leakage include replacement of the tubes, replacement of the pump, and disassembling and cleaning, and rearrangement of the tubes. Note that, since it is assumed that the printer 11 includes a plurality of tubes, replacement of a first tube and replacement of a second tube which is different from the first tube may be performed as different countermeasures. The same is true to pumps, and replacement of the pumps may be performed as different countermeasures. The arrangement of the tube indicates arrangement and a fixed state of the tube in the printer 11. Specifically, the tube rearrangement indicates a countermeasure for checking whether the tubes have been appropriately arranged and correcting the arrangement where appropriate.

The operation information includes information on a lifetime of the pump, information on lifetimes of the tubes, information on an ink use amount, and information on a print amount. In this way, learning accuracy may be improved when operation information which may highly relates to the liquid leakage is determined as the training data. Note that the operation information used for the training data is not limited to the example of FIG. 9, and a portion may be omitted or other operation information may be added. For example, the operation information may include ink color information and color material information. The color information indicates ink colors, such as cyan and magenta. The color material information indicates color material, such as pigment or dye. Sedimentation properties are different depending on ink colors and color materials, and therefore, deterioration degrees of the tubes are different. Therefore, a recommended countermeasure for the liquid leakage may be appropriately learnt by inputting the ink color information and the color material information. Furthermore, the operation information may include temperature information of the printer 11. When a temperature is low, for example, a viscosity degree of ink is increased, and therefore, tube clogging easily occurs, and as a result, probability of occurrence of the liquid leakage is also increased. Therefore, a recommended countermeasure for the liquid leakage may be appropriately learnt by inputting the temperature information.

### 2.3 Concrete Example of Learning

A learning process based on data sets will be described in detail. Here, a machine learning using a neural network will be described.

FIG. 10 is an example of a basic configuration of the neural network. The neural network is a mathematical model for simulating a brain function on a computer. Each circle in FIG. 10 is referred to as a node or a neuron. In the example of FIG. 10, the neural network includes an input layer, two intermediate layers, and an output layer. The input layer is denoted by I, the intermediate layers are denoted by H1 and H2, and the output layer is denoted by O. Furthermore, in the example of FIG. 10, the number of neurons in the input layer is three, the number of neurons in each of the intermediate layers is four, and the number of neurons in the output layer is one. Note that the number of intermediate layers and the numbers of neurons included in the individual layers may be variously modified. Each of the neurons included in the input layer is coupled to the neurons included in the first intermediate layer H1. Each of the neurons included in the first intermediate layer is coupled to the neurons included in the second intermediate layer H2, and each of the neurons included in the second intermediate layer is coupled to the neuron included in the output layer. Note that the intermediate layers may be referred to as hidden layers.

The input layer includes the neurons which output respective input values. In the example of FIG. 10, the neural network receives x₁, x₂, and x₃ as inputs, and the neurons in the input layer output x₁, x₂, and x₃, respectively. Note that certain preprocessing may be performed on the input values so that the neurons included in the input layer output values obtained after the preprocessing.

In the neurons in the intermediate layers onwards, a calculation of simulating a state in which information is transmitted as an electric signal in a brain is performed. In a brain, easiness of transmission of information is changed depending on coupling degrees of synapses, and therefore, the coupling degrees are indicated by weights W in the neural network.

In FIG. 10, “W1” indicates a weight between the input layer and the first intermediate layer. Here, “W1” indicates aggregation of a weight of a given neuron included in the input layer and a weight of a given neuron included in the first intermediate layer. When a weight between a p-th neuron in the input layer and a q-th neuron in the first intermediate layer is denoted by “w¹_{pq}”, the weight W1 of FIG. 10 is information including 12 weights w¹₁₁ to w¹₃₄. The weight W1 means information including a number of weights corresponding to a product of the number of neurons included in the input layer and the number of neurons included in the first intermediate layer in a broad sense.

In the first intermediate layer, a calculation based on Expression (1) is performed on a first neuron. In one neuron, outputs of neurons in a preceding layer coupled to the neuron are subjected to a product-sum operation and a bias is further added to a resultant value. The bias in Expression (1) is denoted by b₁.

$${h}_{1} = f ( {\sum }_{j} {w}_{i 1}^{1} \cdot {x}_{i} + {b}_{1} ) \qquad ( 1 )$$

Furthermore, as illustrated in Expression (1), in a calculation in one neuron, an activating function f which is a non-linear function is used. An ReLU function indicated by Expression (2) below is used as the activating function f, for example. In the ReLU function, when a variable is 0 or less, 0 is selected and when a variable is larger than 0, a value of the variable itself is selected. However, various functions may be generally used as the activating function f, and a sigmoid function or a function obtained by modifying the ReLU function may be used. Although a calculation formula about hi is illustrated in Expression (1), the similar calculation is performed on the other neurons included in the first intermediate layer.

$$f ( x ) = max ( 0 , x ) = \{ \begin{matrix}0 ( x \leq 0 ) \\ x ( x \geq 0 )\end{matrix} \qquad ( 2 )$$

The same is true to the layers onwards. Assuming that a weight between the first and second intermediate layers is denoted by “W2”, in each of the neurons included in the second intermediate layer, a product-sum operation is performed using outputs of the first intermediate layer and the weight W2, a bias is added, and a calculation of applying an activating function is performed.

In the neuron included in the output layer, outputs of the preceding layer are added by weighting and a bias is added. In the example of FIG. 10, the preceding layer of the output layer is the second intermediate layer. In the neural network, a result of the calculation in the output layer corresponds to an output of the neural network. Alternatively, certain post-processing may be performed on a result of the calculation in the output layer and a result of the post-processing may be output.

As is apparent from the description above, an appropriate weight and an appropriate bias are required to be set to obtain a desired output from an input. Note that the weight may be referred to as a weighting coefficient hereinafter. Furthermore, a bias may be included in the weighting coefficient. In the learning, data sets of given inputs x and appropriate outputs for the inputs which are associated with each other are prepared. An appropriate output is supervised data t. The learning process in the neural network may be considered as a process of obtaining a most probable weighting coefficient based on the data sets. In the learning process in the neural network, backpropagation is widely used.

FIG. 11 is a diagram illustrating the backpropagation. Note that, for simplicity of description, processing is performed while only one neuron is focused in each of the first intermediate layer, the second intermediate layer, and the output layer in FIG. 11. Furthermore, the learning process in the neural network is not limited to that using the backpropagation.

In the backpropagation, a forward pass and a backward pass are repeatedly performed so that a parameter is updated. Here, the parameter indicates the weighting coefficient described above. First, an output y is calculated using the input x and weighting coefficients at individual time points. Note that various settings may be performed as an initial value of the weighting coefficient. In the example of FIG. 11, calculations in Expressions (3) to (5) are performed so that y is obtained from xk. In Expression (3) to (5), “u” indicates an output of the first intermediate layer and “v” indicates an output of the second intermediate layer.

$$\begin{matrix}y = {\sum }_{k = 1}^{n} ( {w}_{k}^{3} \cdot {v}_{k} ) + b & ( 3 ) \\ v = f ( {\sum }_{k = 1}^{n} ( {w}_{k}^{2} \cdot {u}_{k} ) + {b}^{2} ) & ( 4 ) \\ u = f ( {\sum }_{k = 1}^{n} ( {w}_{k}^{1} \cdot {x}_{k} ) + {b}^{1} ) & ( 5 )\end{matrix}$$

Then a loss function E is obtained based on the obtained output y and supervised data t corresponding to the input x. Although the loss function E is represented by Expression (6), the loss function E may be a simple difference (y-t) or another loss function may be used. A process performed until the loss function E is obtained is referred to as a forward pass.

E=½(y-t)² (6)

After the loss function E is obtained by the forward pass, parameters are updated using partial differentials of the loss function E as illustrated in Expressions (7) to (12). In Expressions (7) to (12) below, values to which an index “+1” is added indicate values obtained after the update process. For example, “b₊₁” indicates a value of b obtained after the update process. Furthermore, “η” indicates a learning rate. The learning rate is preferably not constant but is changed in accordance with a learning state.

$$\begin{matrix}{b}_{+ 1} = b - η \frac{\partial E}{\partial b} & ( 7 ) \\ {w}_{k + 1}^{3} = {w}_{k}^{3} - η \frac{\partial E}{\partial {w}_{k}^{3}} & ( 8 ) \\ {b}_{k + 1}^{2} = {b}_{k}^{2} - η \frac{\partial E}{\partial {b}_{k}^{2}} & ( 9 ) \\ {w}_{k + 1}^{2} = {w}_{k}^{2} - η \frac{\partial E}{\partial {w}_{k}^{2}} & ( 10 ) \\ {b}_{k + 1}^{1} = {b}_{k}^{1} - η \frac{\partial E}{\partial {b}_{k}^{1}} & ( 11 ) \\ {w}_{k + 1}^{1} = {w}_{k}^{1} - η \frac{\partial E}{\partial {w}_{k}^{1}} & ( 12 )\end{matrix}$$

In this case, the partial differentials of the loss function E for the parameters are calculated using a chain rate in a direction from the output layer to the input layer. Specifically, the partial differentials in Expressions (7) to (12) may be easily obtained by calculating Expressions (13) to (18) below in turn. Furthermore, when the ReLU function of Expression (2) above is used as the activating function f, the differential value is 0 or 1, and therefore, a calculation of the partial differentials may be easily performed. A series of processes using Expressions (7) to (18) is referred to as a backward pass.

$$\begin{matrix} \frac{\partial E}{\partial b} = \frac{\partial E}{\partial y} \cdot \frac{\partial y}{\partial b} = ( y - t ) & ( 13 ) \\ \frac{\partial E}{\partial {w}_{k}^{3}} = \frac{\partial E}{\partial y} \frac{\partial y}{\partial {w}_{k}^{3}} = ( y - t ) \cdot {v}_{k} & ( 14 ) \\ \frac{\partial E}{\partial {b}_{k}^{2}} = \frac{\partial E}{\partial y} \cdot \frac{\partial y}{\partial {v}_{k}} \cdot \frac{\partial {v}_{k}}{\partial {b}_{k}^{2}} = ( y - t ) \cdot {w}_{k}^{3} \cdot {f}^{′} ( {v}_{k} ) & ( 15 ) \\ \frac{\partial E}{\partial {w}_{k}^{2}} = \frac{\partial E}{\partial y} \cdot \frac{\partial y}{\partial {v}_{k}} \cdot \frac{\partial {v}_{k}}{\partial {w}_{k}^{2}} = ( y - t ) \cdot {w}_{k}^{3} \cdot {f}^{′} ( {v}_{k} ) \cdot {u}_{k} & ( 16 ) \\ \frac{\partial E}{\partial {b}_{k}^{1}} = \frac{\partial E}{\partial y} \cdot \frac{\partial y}{\partial {v}_{k}} \cdot \frac{\partial {v}_{k}}{\partial {u}_{k}} \cdot \frac{\partial {u}_{k}}{\partial {b}_{k}^{1}} = ( y - t ) \cdot {w}_{k}^{3} \cdot {f}^{′} ( {v}_{k} ) \cdot {w}_{k}^{2} \cdot {f}^{′} ( {u}_{k} ) & ( 17 ) \\ \frac{\partial E}{\partial {w}_{k}^{1}} = \frac{\partial E}{\partial y} \cdot \frac{\partial y}{\partial {v}_{k}} \cdot \frac{\partial {v}_{k}}{\partial {u}_{k}} \cdot \frac{\partial {u}_{k}}{\partial {w}_{k}^{1}} = ( y - t ) \cdot {w}_{k}^{3} \cdot {f}^{′} ( {v}_{k} ) \cdot {w}_{k}^{2} \cdot {f}^{′} ( {u}_{k} ) \cdot {x}_{k} & ( 18 )\end{matrix}$$

For example, the learning device 100 generates a single neural network for one type of error. Specifically, the learning device 100 generates a first neural network for the ejection failure and a second neural network for the liquid leakage. Naturally, the number of types of error may be three or more, and the learning device 100 generates a number of neural networks corresponding to the number of types of error.

When the first neural network for the ejection failure is generated, the input x is operation information for the ejection failure. As illustrated in FIG. 8, the information on lifetimes of consumables corresponds to numerical value data indicating a rate of a use time to an expected lifetime, for example. Specifically, a single numerical value indicating the information on lifetimes of consumables corresponds to data input to a single neuron in the input layer. The information on an ink use amount is numerical value data representing an amount of consumption of ink by the kilogram, for example. The information on a print amount is numerical value data representing a length of the sheet 13 used in the printing by the meter. Note that each numerical value data may be input to the neural network after being subjected to preprocessing, such as a normalization process. In the example of FIG. 8, the number of neurons included in the input layer is four, for example.

Furthermore, the operation information may include information on a use history of consumables and information on a job history as described above. The information on a use history of consumables is indicated by a 2xk-order vector obtained by collecting k pairs of consumables use start timings and consumables use end timings (k is a positive integer), for example. The use start timings and the use end timings are numerical value data represented by a time difference or the like based on an error occurrence time point, for example. In this way, the information on a use history of consumables may be represented by numerical data. In this case, the information on a use history of consumables serves as data input to the 2xk neurons included in the input layer. Note that the information on a use history of consumables may be a pair of use start timing and a continuous use time or a plurality of numerical value data indicating change of lifetimes with time. Specifically, a process of converting the information on a use history of consumables stored in the server system 410 into input data of the neural network may be variously modified.

Similarly, when the job history information is used as the input data, the conversion process may be variously modified. Note that, when the job history information is used, image data to be printed in a print job may be used as the input data. In a learning process using image data, a convolutional neural network (CNN) which is widely used, for example, may be used. The CNN includes a convolutional layer and a pooling layer. A convolutional calculation is performed in the convolutional layer. Here, the convolutional calculation is specifically a filter process. A process of reducing horizontal and vertical sizes of data is performed in the pooling layer. In the CNN, when image data is input, for example, a process taking the relationship between a given pixel and pixels in the vicinity of the given pixel into consideration may be performed. In the CNN, characteristics of a filter used in the convolutional calculation is learnt by the machine learning. Specifically, the weighting coefficients in the neural network include the filter characteristics in the CNN.

Furthermore, the one neuron included in the output layer corresponds to one type of countermeasure, for example. When the first neural network for the ejection failure is generated, the number of neurons included in the output layer corresponds to the number of expected countermeasures against the ejection failure. For example, when four countermeasures against the ejection failure including cleaning, nozzle wiping cleaning, nozzle replacement, and tube replacement are estimated, the number of neurons included in the output layer is four.

Countermeasure information used as the supervised data t is numerical value data which is 1 when an error is resolved by the corresponding countermeasure and 0 otherwise, for example. When the ejection failure is resolved by cleaning, for example, the supervised data t of the neuron corresponding to the cleaning is 1, and supervised data t in the other three neurons corresponding to the nozzle wiping cleaning, the nozzle replacement, and the tube replacement are 0.

Furthermore, the countermeasure information is not limited to binary data. For example, when the report information indicates a mode in which an appropriate countermeasure which has resolved an error and an inappropriate countermeasure which has not resolved an error may be input, the individual countermeasures may be categorized into one of three categories “executed and appropriate”, “executed and inappropriate”, “not executed”. The countermeasure information in this case may be indicated by 1 for the countermeasure corresponding to the category “executed and appropriate” and 0 for the countermeasure corresponding to the category “executed and inappropriate”, and an intermediate value, that is, 0.5 or the like, for the countermeasure corresponding to the category “not executed”.

A machine-learned model which is a learning result receives the operation information as an input and outputs data indicating a recommended countermeasure as an output. In the example described above, an output of a neuron corresponding to a recommended countermeasure is a value near 1 and an output of a neuron corresponding to a non-recommended countermeasure is a value near 0.

The same is true to the second neural network for the liquid leakage, and information on a weighting coefficient is determined based on a learning process using the operation information for the liquid leakage as the input x and countermeasure information including a countermeasure which has resolved the liquid leakage as the supervised data t.

As described above, the learning section 120 generates a machine-learned model by the machine learning. The method of this embodiment may be applied to the machine-learned model. The machine-learned model is used to determine a recommended countermeasure against an error generated in the electronic apparatus. The information on a weighting coefficient is set in the machine-learned model having an input layer, an intermediate layer, and an output layer, based on data sets including error information, operation information, and countermeasure information which are associated with one another. The information on a weighting coefficient includes a first weighting coefficient between the input layer and the intermediate layer and a second weighting coefficient between the intermediate layer and the output layer. In the example of FIG. 10, the first weighting coefficient is indicated by W1 and the second weighting coefficient is indicated by W3. Furthermore, when two or more intermediate layers are included, the information on a weighting coefficient may include a weighting coefficient between a given intermediate layer and a succeeding intermediate layer. The information on a weighting coefficient includes the weight W2, for example, in the example of FIG. 10.

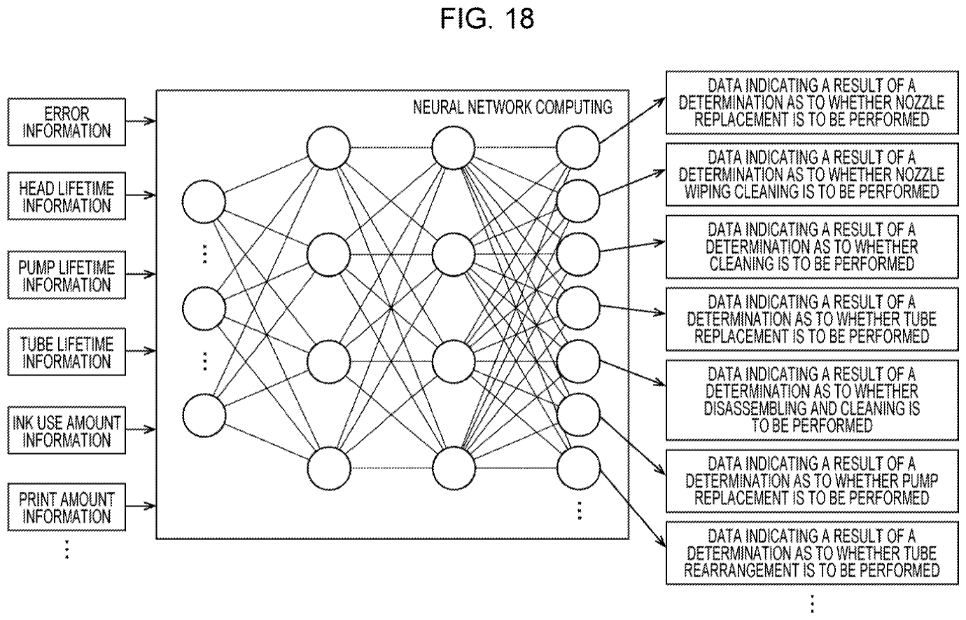

The machine-learned model receives the error information and the operation information as inputs. The machine-learned model causes the computer to input the received operation information in the input layer, perform a calculation based on the set information on a weighting coefficient, and output data indicating a recommended countermeasure against an error indicated by the error information from the output layer. The machine-learned model herein is aggregation of a plurality of machine-learned models set for individual types of error, for example. Alternatively, as described hereinafter with reference to FIG. 18, the machine-learned model may cause the computer to input both the received error information and the received operation information in the input layer, perform a calculation based on the set information on a weighting coefficient, and output data indicating a recommended countermeasure against an error indicated by the error information from the output layer.

Note that an example of generation of a neural network for each type of error is illustrated as described above. Therefore, the error information included in the data set in a learning step is used to specify a neural network to be learnt and the operation information is used as the input x. Furthermore, in an estimation step, among the error information and the operation information obtained as inputs, the error information is used to specify a machine-learned model to be used in the estimation process and the operation information is used as an input to the machine-learned model. However, the process in this embodiment is not limited to this and the error information may be input to the input layer of the machine-learned model. Details will be described hereinafter as a modification.

Note that a machine-learned model uses a neural network in the description hereinabove as an example. However, the machine learning in this embodiment is not limited to the method using a neural network. For example, various general machine learning methods, such as a support vector machine (SVM), or a further developed machine learning method may be applied as the method of this embodiment, for example.

### 3. Estimation Process

### 3.1 Example of Configuration of Estimation Device

FIG. 12 is a diagram illustrating an example of a configuration of an information processing device 200 serving as an estimation device of this embodiment. The information processing device 200 includes a reception section 210, a processing section 220, and a storage section 230.

The storage section 230 stores a machine-learned model obtained by mechanically learning a condition of a recommended countermeasure against an error indicated by the error information based on data sets in which the error information, the operation information, and the countermeasure information are associated with one another. The error information, the operation information, and the countermeasure information have been described above. The reception section 210 receives the error information and the operation information transmitted from the electronic apparatus. The processing section 220 performs a process of displaying a recommended countermeasure against an error indicated by the received error information based on a machine-learned model. Specifically, the processing section 220 obtains data indicating results of determinations as to whether countermeasures which are set in advance are to be recommended using the machine-learned model. The data indicating results of determinations as to whether the countermeasures are to be recommended is not limited to binary data and is numerical value data indicating recommendation degrees or probabilities of recommendation, for example. The processing section 220 performs a process of displaying a recommended countermeasure for the user based on an output of the machine-learned model. Note that the display is not limited to display in the information processing device 200. For example, the information processing device 200 may perform a process of transmitting information for presentation to a device which performs display. The information for presentation is used to generate a display screen, for example. Furthermore, the presentation is not limited to screen display and various methods may be used, such as output of sound by a speaker.

In this way, a countermeasure to be recommended may be appropriately determined based on various operation information. Specifically, even when a large amount of report information is stored in the server system 410, the user is not required to select appropriate information from the large amount of report information and a burden of the user in the determination of a countermeasure may be reduced. With the method of this embodiment, even a user who has less knowledge and less experience may execute an appropriate countermeasure.

Note that the machine-learned model is used as a program module which is a portion of artificial intelligence software. The processing section 220 outputs data indicating a recommended countermeasure against an error indicated by the error information which is an input in accordance with an instruction issued by the machine-learned model stored in the storage section 230.

As with the learning section 120 of the learning device 100, the processing section 220 of the information processing device 200 is configured by hardware which includes at least one of a circuit which processes digital signals and a circuit which processes analog signals. Furthermore, the processing section 220 may be realized by a processor below. The information processing device 200 of this embodiment includes a memory which stores information and a processor which operates based on the information stored in the memory. Various processors may be used, such as a CPU, a GPU, and a DSP, as the processor. The memory may be a semiconductor memory, a register, a magnetic storage device, or an optical storage device.

Note that the calculation performed by the processing section 220 based on the machine-learned model, that is, the calculation for outputting output data based on input data may be executed by software or hardware. That is, a product-sum calculation in Expression (1) above and the like or the filter calculation in the CNN may be executed by software. Alternatively, the calculations may be executed by a circuit device, such as a field-programmable gate array (FPGA). Furthermore, the calculations may be executed by a combination of software and hardware. Accordingly, the operation of the processing section 220 in accordance with an instruction issued by the machine-learned model stored in the storage section 230 may be realized in various modes.

The information processing device 200 illustrated in FIG. 12 is included in the server system 410 of FIG. 3, for example. Specifically, the server system 410 performs a process of receiving error information and operation information from the print system 300 and presenting a recommended countermeasure against an error indicated by the error information based on the machine-learned model. In other words, the reception section 210 of the information processing device 200 is a communication section which collects the error information and the operation information from the electronic apparatus through a network. The network is the network NE2 illustrated in FIG. 3, for example. Furthermore, the communication section is specifically a communication device or a communication interface. By this, in the information collecting system 400 illustrated in FIG. 3, collection of appropriate information and an estimation process may be performed based on the collected information.

Note that the information processing device 200 may be included in an apparatus other than the server system 410. For example, the information processing device 200 is included in an apparatus coupled to the server system 410 through the network NE2. The apparatus performs a process of presenting an appropriate countermeasure by obtaining the error information and the operation information collected by the server system 410 through the network NE2. Furthermore, a single information processing device 200 may be used or a plurality of information processing devices 200 may be used.

### 3.2 Concrete Example of Estimation Process

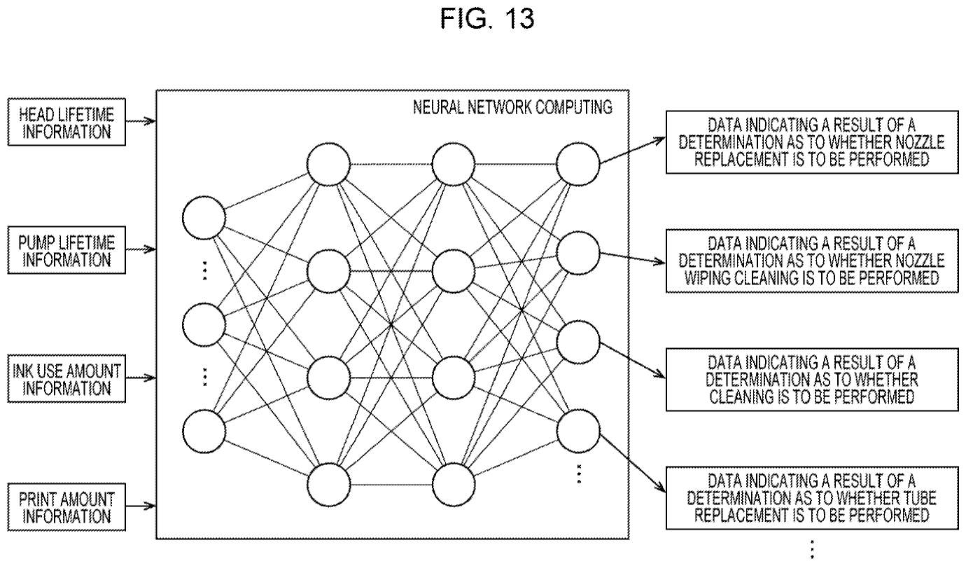

FIG. 13 is a diagram schematically illustrating the relationships between inputs and outputs in the estimation process according to this embodiment. In FIG. 13, inputs and outputs at a time when recommended countermeasures are output against ejection failure are illustrated. Note that, in FIG. 13, neural network computing will be described. Inputs in the estimation process include the operation information. As illustrated in FIG. 13, the operation information includes the information on lifetimes of the print heads, information on a lifetime of the pump, information on an ink use amount, and information on a print amount information, for example. The inputs in the estimation process may further include other operation information, such as event information. Specifically, information used as input data in the learning process serves as an input in the estimation process.

The processing section 220 performs the neural network computing based on the inputs. Then the processing section 220 outputs information indicating recommended countermeasures. For example, the neural network has four outputs and each of the outputs is numerical value data in a range from r to s. Each of the outputs has data of a larger value as a recommendation degree as a countermeasure for resolving the ejection failure is higher. For example, although r is 0 and s is 1, concrete numerical values are not limited to these. In the example of FIG. 13, numerical value data indicating recommendation degrees are output for various countermeasures, that is, nozzle replacement, nozzle wiping cleaning, cleaning, and tube replacement.

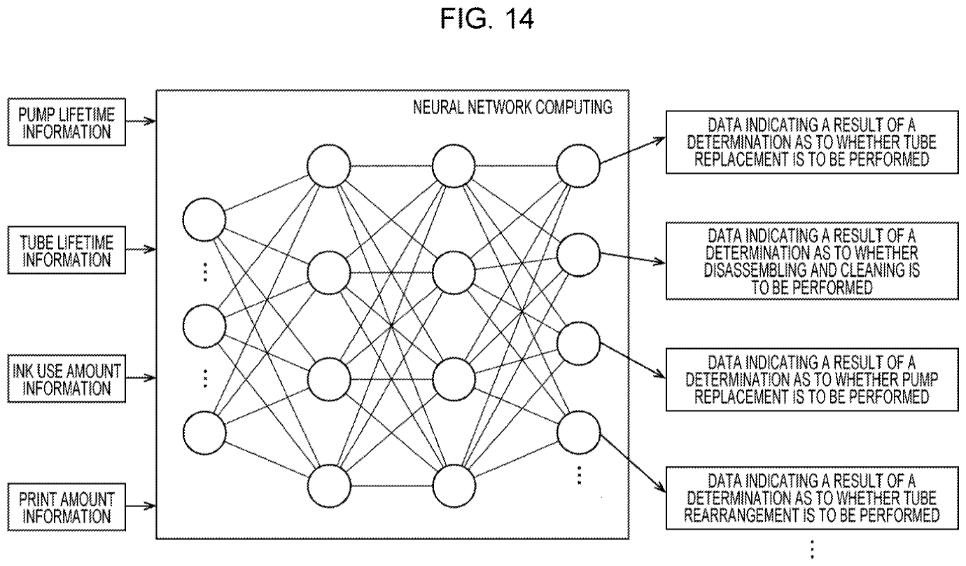

FIG. 14 is a diagram schematically illustrating the relationships between inputs and outputs in the estimation process according to this embodiment. In FIG. 14, inputs and outputs at a time when recommended countermeasures are output against the liquid leakage are illustrated. Inputs in the estimation process include the operation information. As illustrated in FIG. 14, for example, the operation information includes the information on a lifetime of the pump, information on lifetimes of the tubes, information on an ink use amount, and information on a print amount information.

The processing section 220 performs the neural network computing based on the inputs. For example, the neural network has four outputs, and each of the outputs is numerical value data in a range from r to s. Each of the outputs has data of a larger value as a recommendation degree serving as a countermeasure for resolving the liquid leakage is higher. In the example of FIG. 14, numerical value data indicating recommendation degrees are output for various countermeasures, that is, tube replacement, thorough cleaning, pump replacement, and tube rearrangement.

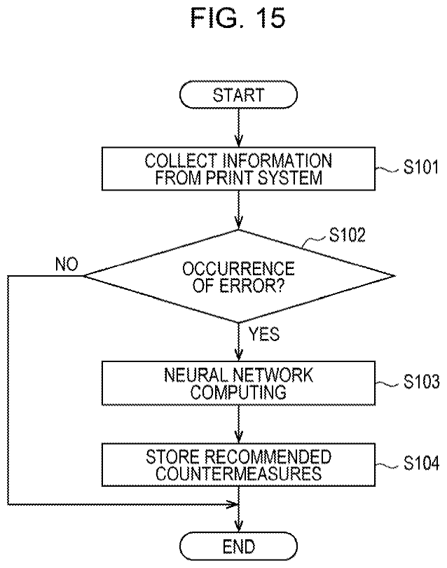

FIG. 15 is a flowchart of a process performed by the processing section 220. The processing section 220 periodically collects the error information and the operation information from the print system 300 (S101). The processing section 220 determines whether an error has occurred in the printer 11 based on the information obtained in step S101 (S102). Specifically, the processing section 220 determines whether error information is included in the information obtained in step S101. When an error has not occurred (No in S102), the process is terminated without performing a process in step S103 onwards.

When an error has occurred (Yes in S102), the processing section 220 performs the neural network computing based on the error information and the operation information (S103). In the example described above, the processing section 220 specifies a machine-learned model to be used in the estimation process based on the error information and inputs the operation information in the machine-learned model so as to perform the neural network computing.

The processing section 220 determines a recommended countermeasure based on a result of the neural network computing and stores the recommended countermeasures (S104). For example, the processing section 220 extracts three countermeasures having higher recommendation degrees from among estimated countermeasures and stores data arranged in order of recommendation degrees in the storage section 230. Note that the process based on the result of the neural network computing is not limited to this, and various modifications may be made. By performing the process illustrated in FIG. 15, a recommended countermeasure may be determined every time an error occurs in the electronic apparatus.

The information processing device 200 may perform push notification indicating a recommended countermeasure along with the error information to the user. For example, when an error notification mail is transmitted, information indicating a recommended countermeasure is added. However, when an error is minor, the user may not be required to perform a countermeasure. Therefore, when a notification of a recommended countermeasure is made every time an error has occurred, the user may feel irritations.

Accordingly, the information processing device 200 may transmit information indicating a recommended countermeasure as a response only when a request is issued by the user. Hereinafter, an example in which the information processing device 200 is included in the server system 410 will be described.

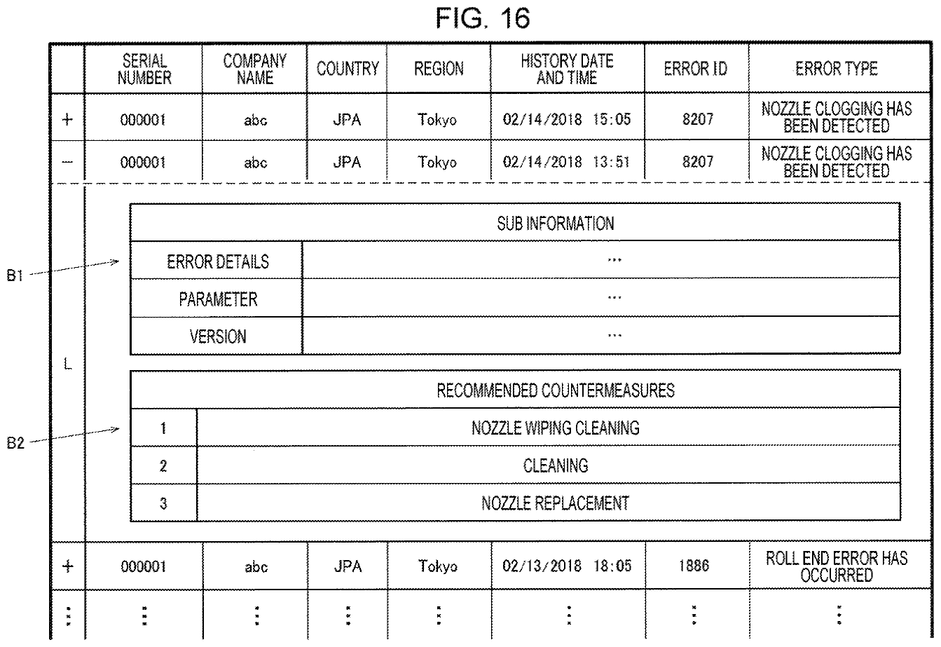

FIG. 16 is a diagram illustrating another example of the error screen. For example, the server system 410 displays detailed information on a selected error as denoted by B1 and B2 in FIG. 16 when a “+” mark displayed in a left end in the error screen in FIG. 5 is operated. The detailed information includes a sub-information denoted by B1 and information on recommended countermeasures denoted by B2. In other words, the server system 410 performs a process of presenting the information on the recommended countermeasures as the detailed information when the user performs an operation of accessing the detailed information of the error. By this, the recommended countermeasures against the error information concerned by the user may be presented.

Note that, although the example in which the neural network computing is performed every time the error information is obtained is illustrated in FIG. 15, the present disclosure is not limited to this. For example, the server system 410 may perform the neural network computing when the user performs the operation of accessing the detailed information on the error.

### 4. Update of Machine-Learned Model

In the description above, the learning process and the estimation process are individually described. For example, the learning device 100 generates a machine-learned model by performing the learning process based on training data accumulated in advance. In the estimation step, the information processing device 200 performs the estimation process by continuously using the generated machine-learned model. In this case, the machine-learned model generated once is fixed and update thereof is not expected.

However, the method in this embodiment is not limited to this and the machine-learned model may be appropriately updated in the estimation step. When a system including the information collecting system 400 illustrated in FIG. 3 is operated, the server system 410 collects information from the print system 300 and the terminal device 420 so as to obtain data sets in which the error information, the operation information, and the report information are associated with one another as needed. Therefore, the server system 410 may update the machine-learned model by performing learning based on the data set. By this, learning using a larger number of data sets is enabled, and therefore, probability of recommendation of appropriate countermeasures may be enhanced. For example, the server system 410 executes the process of updating a machine-learned model using an obtainment of the report information from the terminal device 420 as a trigger.

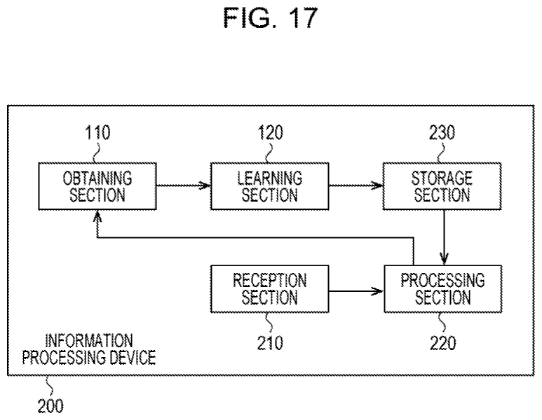

FIG. 17 is a diagram illustrating an example of a configuration of the information processing device 200 when the machine-learned model is updated in the estimation step. The information processing device 200 includes the obtaining section 110 and the learning section 120 in addition to the reception section 210, the processing section 220, and the storage section 230. Specifically, the information processing device 200 of FIG. 17 includes the same components as the learning device 100 illustrated in FIG. 7 in addition to the components illustrated in FIG. 12 and may execute both the learning process and the estimation process. The information processing device 200 illustrated in FIG. 17 is included in the server system 410 of FIG. 3, for example. The learning process and the estimation process may be efficiently executed in the same apparatus when the information processing device 200 illustrated in FIG. 17 is used. Note that, when the machine-learned model is updated in the estimation step, the learning process and the estimation process may be executed in different devices.

### 5. Modification

As described with reference to FIGS. 13 and 14, the example in which different machine-learned models are generated in accordance with types of error is described in the foregoing embodiment. In this case, the machine-learned model is specialized to a specific error, and therefore, input data is easily restricted in the learning step and the estimation step. Specifically, operation information having highest association with an error to be processed is used as input data. Therefore, the number of input data is hardly increased and loads in the learning process and the estimation process may be reduced.

However, the processes in this embodiment are not limited to these, and the learning device 100 may generate a machine-learned model which may cope with a plurality of types of error. The information processing device 200 may determine recommended countermeasures based on a single machine-learned model even when types of error information which are inputs are different. For example, the information processing device 200 may present recommended countermeasures using a single machine-learned model for all possible error information in the electronic apparatus.

FIG. 18 is a diagram illustrating the relationships between inputs and outputs in the estimation process according to the modification. As illustrated in FIG. 18, the error information is used as input data of the estimation process. The error information is also used as input data in the learning process. The error information includes information specifying a type of error, such as an error ID. Furthermore, the operation information serving as the input data includes the various operation information illustrated in FIGS. 13 and 14. Furthermore, other operation information which may be associated with the error to be processed may be included in the input data. Moreover, as illustrated in FIG. 18, outputs are information indicating recommendation degrees of countermeasures which are possibly executed in the target electronic apparatus. Specifically, the countermeasures to be output include the countermeasure against the ejection failure, the countermeasure against the liquid leakage, and countermeasures against the other errors.

The method illustrated in FIG. 18 for sharing a machine-learned model by a plurality of error information is advantageous in that the number of machine-learned models is small and extraction of operation information to be used as input data is not required to be performed by manpower. On the other hand, the method illustrated in FIGS. 13 and 14 for generating machine-learned models for individual error information is advantageous in that the number of input data is small and a processing load is small when a single machine-learned model is focused. In this way, various modifications of the configuration of the machine-learned model may be made and the different configurations have different characteristics. An arbitrary one of the configurations may be used in this embodiment. Furthermore, modifications having other configurations may be made. For example, the learning device 100 may categorize the error information into a number of categories of an ink processing system, a printing medium transport system, a drying system, and the like, and generate machine-learned models for individual categories. A plurality of error information included in the same category have a certain degree of correlation, and therefore, operation information having high correlation may be similar. Therefore, the number of machine-learned models and the number of input data may be suppressed.

As described above, the information processing device 200 according to this embodiment includes the storage section 230, the reception section 210, and the processing section 220. The storage section 230 stores a machine-learned model obtained by mechanically learning a condition of a recommended countermeasure against an error based on data sets in which the error information, the operation information, and the countermeasure information are associated with one another. The error information indicates an error which occurs in the electronic apparatus. The operation information indicates an operation state of the electronic apparatus. The countermeasure information indicates a countermeasure performed on an error. The reception section 210 receives the error information and the operation information transmitted from the electronic apparatus. The processing section 220 performs a process of presenting a recommended countermeasure against an error indicated by the received error information based on a machine-learned model.

According to the method of this embodiment, a recommended countermeasure against an error is presented using a machine-learned model generated by the machine learning based on data sets in which the error information, the operation information, and the countermeasure information are associated with one another. Since the machine-learned model generated based on the countermeasure information is used, a determination may be made taking results of determinations as to whether past countermeasures are appropriate into consideration. Furthermore, since the operation information is used, a determination may be made taking an operation state of the electronic apparatus into consideration in addition to information on a type of error or the like. In this way, a countermeasure which appropriately resolves the error may be determined with high accuracy by using a result of the machine learning based on appropriate training data.

Furthermore, the error is associated with consumables, and the countermeasures may include replacement of consumables and maintenance of consumables.

In this way, when an error associated with the consumables included in the electronic apparatus occurs, a determination as to whether the consumables are to be replaced or maintenance is to be performed may be appropriately made.

Furthermore, the operation information may include information on lifetimes of the consumables.

By this, a recommended countermeasure may be determined based on use states of the consumables.

Furthermore, the operation information may include information on a use history of the consumables or information on a history of jobs using the consumables.

By this, a recommended countermeasure may be determined based on use states of the consumables in time series.

Furthermore, the consumables may be the print heads, and the error may be ejection failure of one of the print heads.

By this, an appropriate countermeasure for resolving the ejection failure may be presented.

Furthermore, the consumables may be the tubes which are supply paths of the ink to be used for printing and the pump used for supply of the ink and the error may be leakage of the ink.

By this, an appropriate countermeasure for resolving the ink leakage may be presented.

Furthermore, the electronic apparatus may include a communication section which collects the error information and the operation information from the electronic apparatus through a network.

By this, in the information processing device 200 which collects information from the electronic apparatus, when an error is included in the collected information, an appropriate countermeasure may be presented.

Furthermore, the learning device 100 of this embodiment includes the obtaining section 110 and the learning section 120. The obtaining section 110 obtains error information indicating an error generated in the electronic apparatus, operation information indicating an operation state of the electronic apparatus, and countermeasure information indicating a countermeasure against the error. The learning section 120 mechanically learns a condition of a recommended countermeasure against the error indicated by the error information based on data sets in which the error information, the operation information, and the countermeasure information are associated with one another.

According to the method of this embodiment, since the countermeasure information is used for the machine learning, a result of learning may be obtained taking results of determinations as to whether past countermeasures have been appropriately performed into consideration. Furthermore, since the operation information is used in the machine learning, a result of learning may be obtained taking an operation state of the electronic apparatus into consideration in addition to information on a type of error and the like into consideration.

Furthermore, the machine-learned model according to this embodiment is used to determine a recommended countermeasure against an error generated in the electronic apparatus and has the input layer, the intermediate layer, and the output layer. In the machine-learned model, the weighting coefficient information including the first weighting coefficient between the input layer and the intermediate layer and the second weighting coefficient between the intermediate layer and the output layer is set based on data sets in which the error information indicating the error, the operation information indicating the operation state of the electronic apparatus, and the countermeasure information indicating the countermeasure against the error which are associated with one another. The machine-learned model causes the computer to receive the error information and the operation information as inputs, input at least the operation information in the input layer, perform a calculation based on the set information on the weighting coefficient, and output data indicating a recommended countermeasure against the error indicated by the error information received as the input from the output layer.

In this way, since the information on the weighting coefficient is learnt by the learning process, a machine-learned model which may determine a recommended countermeasure against the error may be generated. Specifically, a machine-learned model using the neural network may be generated.

Although the embodiment has been described in detail above, those skilled in the art may easily understood that various modifications may be made without nominally departing from novelty and effects of this embodiment. Therefore, such modifications are all included in the scope of the present disclosure. For example, terms which are described at least once along with different terms which have wide meanings or which have the same meanings may be replaced by the corresponding different terms in any portion in the specification and the drawings. Furthermore, all combinations of the embodiment and the modifications are included in the scope of the present disclosure. Furthermore, configurations and operations of the learning device, the information processing device, and the system including the learning device and the information processing device are also not limited to those described in this embodiment, and various modifications may be made.

What is claimed is:

1. An information processing device comprising:
a storage configured to store a machine-learned model obtained by mechanically learning a condition of a recommended countermeasure against an error based on a data set in which error information indicating the error generated in an electronic apparatus, operation information indicating an operation state of the electronic apparatus, and countermeasure information indicating the countermeasure performed against the error are associated with one another;
a reception section configured to receive the error information and the operation information transmitted from the electronic apparatus; and
a prosessor configured to present the recommended countermeasure against the error indicated by the received error information based on the machine-learned model.

2. The information processing device according to claim 1, wherein
the error is associated with consumables, and
the countermeasure includes replacement of the consumables and maintenance of the consumables.

3. The information processing device according to claim 2, wherein the operation information includes information on lifetimes of the consumables.

4. The information processing device according to claim 2, wherein the operation information includes information on a use history of the consumables or information on a history of jobs using the consumables.

5. The information processing device according to claim 2, wherein
the consumables are print heads, and
the error is ejection failure of the print heads.

6. The information processing device according to claim 2, wherein
the consumables are tubes which are paths for supplying ink used in printing and a pump used for supply of the ink, and
the error is leakage of ink.

7. The information processing device according to claim 1, further comprising a communication section configured to collect the error information and the operation information from the electronic apparatus through a network.

8. A learning device comprising:
an obtaining section configured to obtain error information indicating an error generated in an electronic apparatus, operation information indicating an operation state of the electronic apparatus, and countermeasure information indicating a countermeasure performed against the error; and
a learning section configured to mechanically learn a condition of a recommended countermeasure against the error indicated by the error information based on a data set in which the error information, the operation information, and the countermeasure information are associated with one another.

9. A non-transitory computer-readable recording medium storing a machine-learned model used to determine a recommended countermeasure against an error generated in an electronic apparatus, wherein
the machine-learned model
includes an input layer, an intermediate layer, and an output layer,
has weighting coefficient information including a first weighting coefficient between the input layer and the intermediate layer and a second weighting coefficient between the intermediate layer and the output layer which is set based on a data set in which error information indicating the error, operation information indicating an operation state of the electronic apparatus, countermeasure information indicating the countermeasure performed against the error are associated with one another, and
causes a computer to receive the error information and the operation information as inputs, input at least the operation information in the input layer, perform a calculation based on the set weighting coefficient information, and output data indicating the recommended countermeasure against the error indicated by the error information received as the input from the output layer.
